(19) United States
(12) Patent Application Publication
(10) Pub. No.: US 2004/0151411 A1
(43) Pub. Date: Aug. 5, 2004

(54) Swivel bearing

(75) Inventor: Chin Pao Chang, Gueishan Shiang (TW)

Correspondence Address: BACON & THOMAS, PLLC, 625 SLATERS LANE, FOURTH FLOOR, ALEXANDRIA, VA, 22314

(73) Assignee: CHUN PIAO CO., LTD., Banchiau City (TW)

(21) Appl. No.: 10/358,352

(22) Filed: Feb. 5, 2003

(51) Int. Cl. F16C 23/00

(52) U.S. Cl. 384/247

(57) ABSTRACT

A swivel bearing includes a base for connecting to a first member and a swivel gear for connecting to a second member to be turned relative to the first member. The base is provided on a top with a substantially ring-shaped receiving seat, into which the swivel gear is rotatably mounted. A threaded hole is provided on a predetermined position on the receiving seat for a screwing element to screw thereinto and set the receiving seat to a desired tightness relative to the swivel gear mounted therein. Thus, the second member may be turned to locate at a desired angular position relative to the first member.

### FIELD OF THE INVENTION

The present invention relates to a swivel bearing including a base for connecting to a first member and a swivel gear rotatably mounted in a tightness adjustable receiving seat on the base for connecting to a second member to be turned relative to the first member.

### BACKGROUND OF THE INVENTION

FIGS. 1, 2, and 3 together show a conventional swivel bearing 1, which mainly includes from top to bottom a stop ring 11, a swivel seat 12, an elastic ring 13, and a base 14. The stop ring 11 has through holes 111 formed thereon for screwing elements 15 to extend therethrough, and has a stopper 112 provided at one side of an outer edge thereof. The swivel seat 12 is provided at two opposite sides with two upward extended lugs 121, on each of which a through hole 122 is formed for a threaded head 162 of a connecting rod 16 to extend from an outer side to an inner side of the lug 121 to engage with a nut 17. A portion of each connecting rod 16 other than the threaded head 161 serves as a connecting arm 162 having through holes 163 spaced thereon for a second member 18 to connect thereto with screwing elements. Further, the swivel seat 12 is provided at a predetermined position with a stop rod 123 adapted to engage with the stopper 112 on the stop ring 11. The base 14 has a central opening surrounded by an axially extended annular flange 141 formed on a top thereof. Threaded holes 142 are spaced along an end surface of the annular flange 141 corresponding to the through holes 111 on the stop ring 11 for engaging with the screwing elements 15 extended through the holes 111. The base 14 is also provided with through holes 143 for connecting to a first member 19. The elastic ring 13 and a washer 131 are located on the base 14 around the annular flange 141.

To mount the conventional swivel bearing 1 to the first and the second member 19 and 18, first thread screwing elements 182 through the holes 163 on the connecting rods 16 into threaded holes 181 provided on the second member 18 to connect the second member 18 to the swivel seat 12. Then, thread screwing elements 192 through the holes 143 on the base 14 into threaded holes 191 provided on the first member 19 to connect the first member 19 to the base 14. With the elastic ring 13 and the screwing elements 15, a tightness against which the second member 18 is turned and located at an angular position relative to the first member 19 can be set and adjusted.

In brief, the elastic ring 13 is the element for controlling the tightness against which the first and the second member 19, 18 are turned and located relative to one another. The elastic ring 13 is made of a metal material that tends to deform and result in lowered function thereof. Moreover, surfaces of the elastic ring 13 frequently frictionally contacting with the swivel seat 12, the washer 131, and the base 14 tend to rust and result in difficult turning of the second member 18 relative to the first member 19.

Taiwanese New Utility Model Patent published under No. 495130 discloses a flat display device and a swivel gear thereof. The flat display device is connected to a swivel seat via a pivot shaft extended from a connecting side of the display device. The swivel seat forms a first cylinder, which is formed at two opposite sides with two recesses. A fixing seat is fixed onto a computer mainframe and forms a second cylinder that has a central through hole for receiving the swivel seat therein and two slots formed on two opposite sides of the central through hole. An elastic member having a flange is located in each slot. When the swivel seat is turned within the fixing seat to a fixed position, the recesses thereof would engage with the flanges of the elastic members on the fixing seat to provide a good locating effect.

The flanges of the elastic members frictionally contact with a circumference of the swivel seat to produce a pre-torsion, so that the swivel seat can rotate only when a fixed value of torsion is applied thereto. However, the flanges on the elastic members are in a compressed state when they frictionally contact with the circumference of the swivel seat, and would restore to their original state only when the swivel seat is turned within the fixing seat to the fixed position, at where the recesses engage with the flanges of the elastic members. Therefore, the elastic members tend to become elastically fatigued under the frequently compressed state and gradually lose their locating function.

Once the elastic ring 13 and the elastic members disclosed in Taiwanese New Utility Model Patent published under No. 495130 become deformed or elastically fatigued and could not be used any longer, it is very difficult to repair them. And, the repaired elastic ring and/or elastic members are subject to subsequent deformation or elastic fatigue.

It is therefore tried by the inventor to develop an improved swivel bearing to overcome the drawbacks existed in the conventional swivel bearing or swivel gear.

### SUMMARY OF THE INVENTION

A primary object of the present invention is to provide a bearing gear that enables adjustment of a torsion required to turn a first member relative to a second member.

Another object of the present invention is to provide a bearing gear that enables a first and a second member to be turned relative to one another clockwise or counterclockwise.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional swivel bearing;

FIG. 2 is an assembled view of FIG. 1;

FIG. 3 shows the connection of the conventional swivel bearing of FIG. 2 to two members to be turned relative to one another;

FIG. 4 is an exploded top perspective view of a swivel bearing according to a preferred embodiment of the present invention;

FIG. 5 is an assembled perspective view of FIG. 4;

FIG. 6 is an exploded bottom perspective view of the swivel bearing of FIG. 4;

FIG. 7 is an assembled perspective view of FIG. 6;

FIG. 8 shows the connection of the swivel bearing of the present invention to two members to be turned relative to one another;

FIG. 9 is a sectional view taken along line A-A of FIG. 4 to show the manner of increasing a tightness of the swivel bearing;

FIG. 10 is a sectional view taken along line A-A of FIG. 4 to show the manner of decreasing a tightness of the swivel bearing;

FIG. 11 is a perspective view showing the turning of one of two members connected to one another via the swivel bearing of the present invention; and

FIG. 12 is another perspective view showing the turning of one of two members connected to one another via the swivel bearing of the present invention.

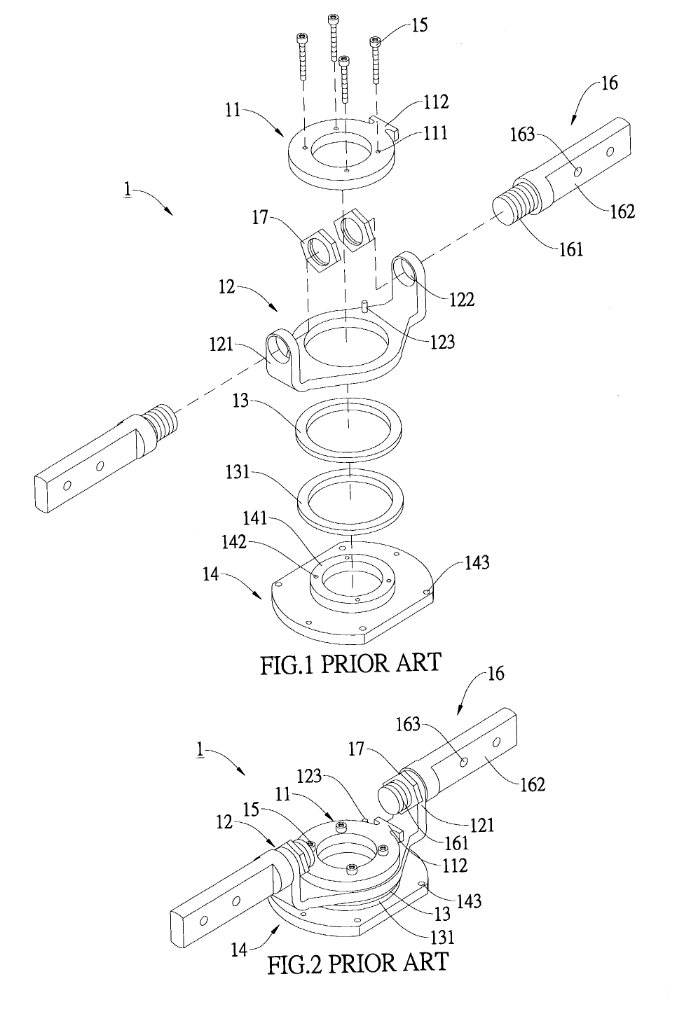

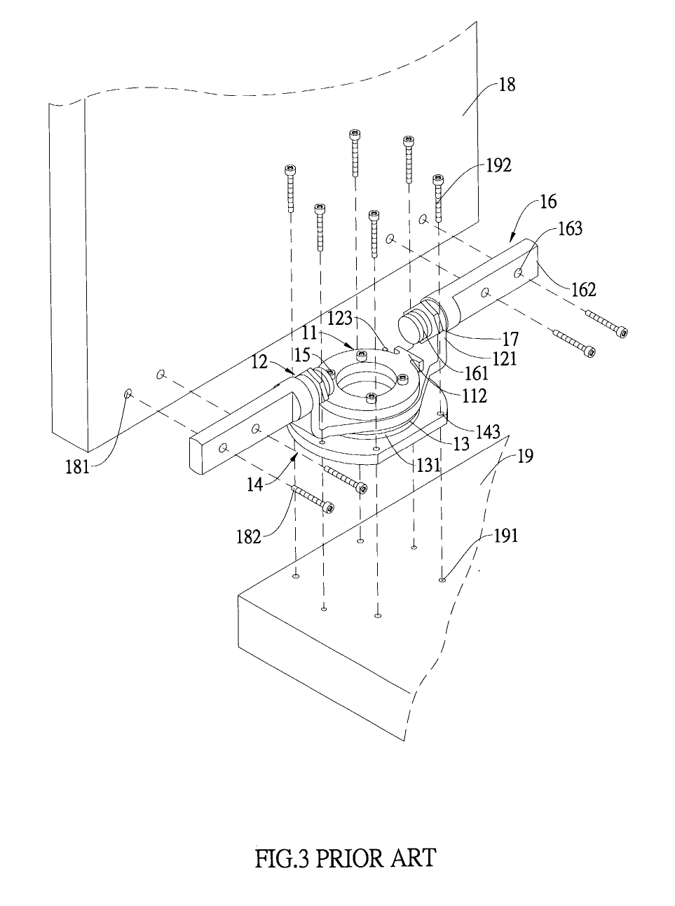

### DETAILED DESCRIPTION OF THE PREFERRED EMBODIMENTS

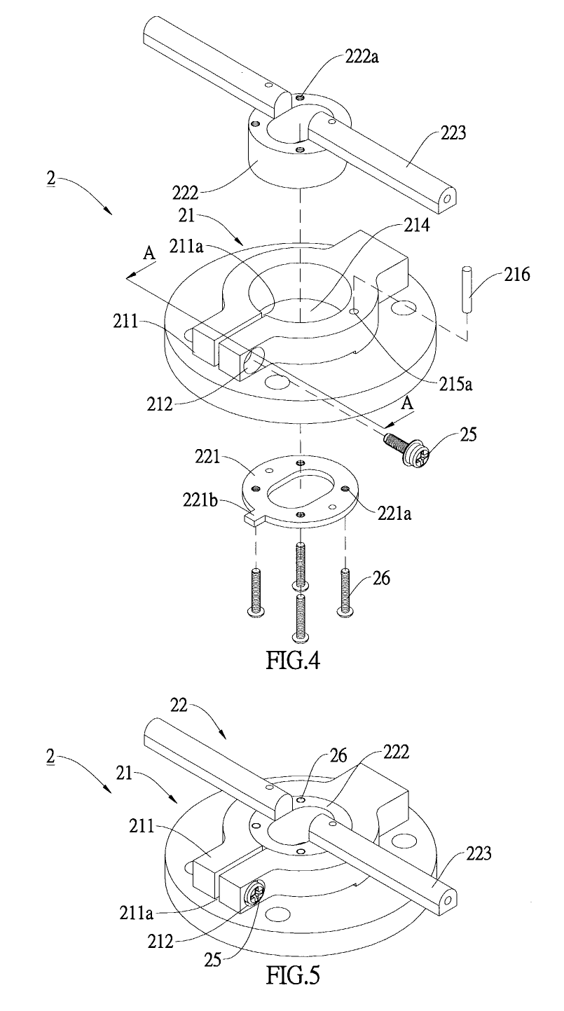

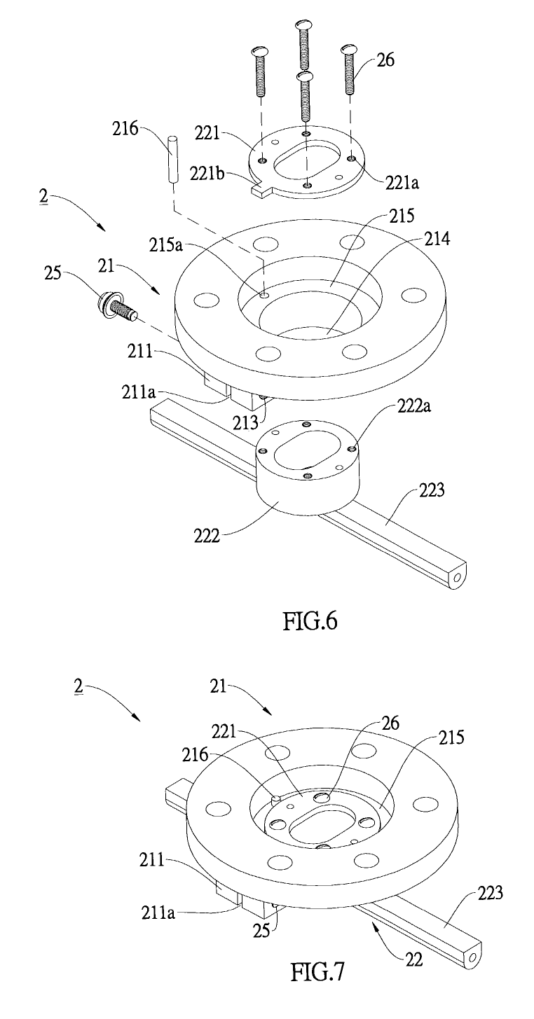

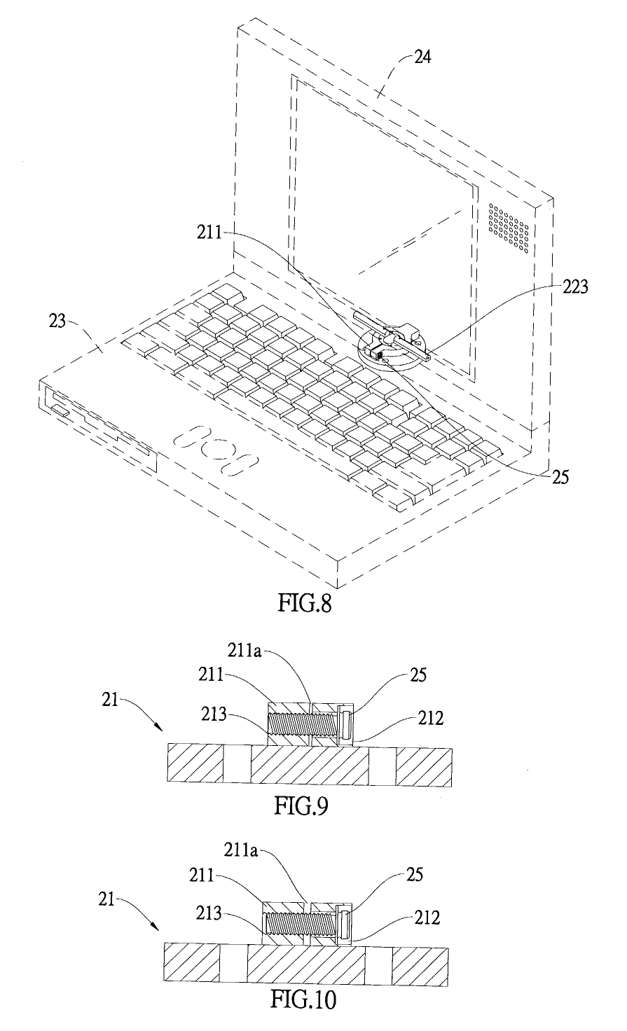

Please refer to FIGS. 4 to 8 in which a swivel bearing 2 according to a preferred embodiment of the present invention is shown. The swivel bearing 2 mainly includes a base 21 for connecting to a first member 23, and a swivel gear 22 turnably mounted on the base 21.

The base 21 is provided on a top with a receiving seat 211. The receiving seat 211 includes a central ring portion having two diametrically opposite and radially projections, one of which is formed into two radially parallel arms with a clearance 211a existed therebetween. One of the two parallel arms is provided with a transverse through hole 212 and the other arm is provided with a transverse threaded hole 213 corresponding to and aligned with the through hole 212, so that a screwing element 25 may be screwed into the threaded hole 213 via the through hole 212 to bring the two arms closer to each other. The base 21 has a step-bore central opening to provide a bore-reduced upper hole to together with a central opening defined by the ring portion of the receiving seat 211 provide an upper receiving hole 214, and a bore-increased lower receiving hole 215. A small through hole 215a is formed on the ring portion of the receiving seat 211 to axially extend through the base 21 into the lower receiving hole 215 for a stop rod 216 to fixedly mount therein.

The swivel gear 22 includes a stop plate 221, a swivel shaft 222, and a pair of connecting arms 223. The stop plate 221 is designed for locating in the lower receiving hole 215 of the base 21 and is provided with threaded holes 221a. The swivel shaft 222 is designed for locating in the upper receiving hole 214 of the base 21 and is provided with threaded holes 222a corresponding to the threaded holes 221a on the stop plate 221 for screwing elements 26 to extend therethrough and fasten the stop plate 221 and the swivel shaft 222 together. Moreover, the stop plate 221 includes a radially outward projection 221b adapted to abut against the stop rod 216 downward extended into the lower receiving hole 215, in which the stop plate 221 is located. The connecting arms 223 are fixedly connected at respective inner ends to two opposite sides on a top of the swivel shaft 222 for a second member 24 to connect thereto.

To assemble the swivel bearing 2 of the present invention, first position the swivel shaft 222 having the connecting arms 223 connected thereto in the upper receiving hole 214 of the base 21, and the stop plate 221 in the lower receiving hole 215 of the base 21, and extend the screwing elements 26 through the threaded holes 221a and 222a provided on the stop plate 221 and the swivel shaft 222, respectively, to connect the stop plate 221 to the swivel shaft 222 and hold them to lower and upper sides of the base 21. Then, fix the stop rod 216 in the through hole 215a, and screw the screwing element 25 into the threaded hole 213 via the hole 212 on the receiving seat 211. Finally, connect the connecting arms 223 to the second member 24 and the base 21 to the first member 23.

Please refer to FIG. 9. When the screwing element 25 is screwed deeply into the threaded hole 213, the two projected arms of the receiving seat 211 are brought closer to each other to reduce the clearance 211a between the two arms, and accordingly, an inner diameter of the upper receiving hole 214 of the base 21. At this point, the swivel shaft 222 and the upper receiving hole 214 are in a tight-fit relation.

FIG. 10 shows the screwing element 25 is loosened from the threaded hole 213 by a predetermined degree for the clearance 211a on the receiving seat 211 to return to an original state thereof, allowing the upper receiving hole 214 to resume its original inner diameter. At this point, the swivel shaft 222 is located in the upper receiving hole 214 in a normal state.

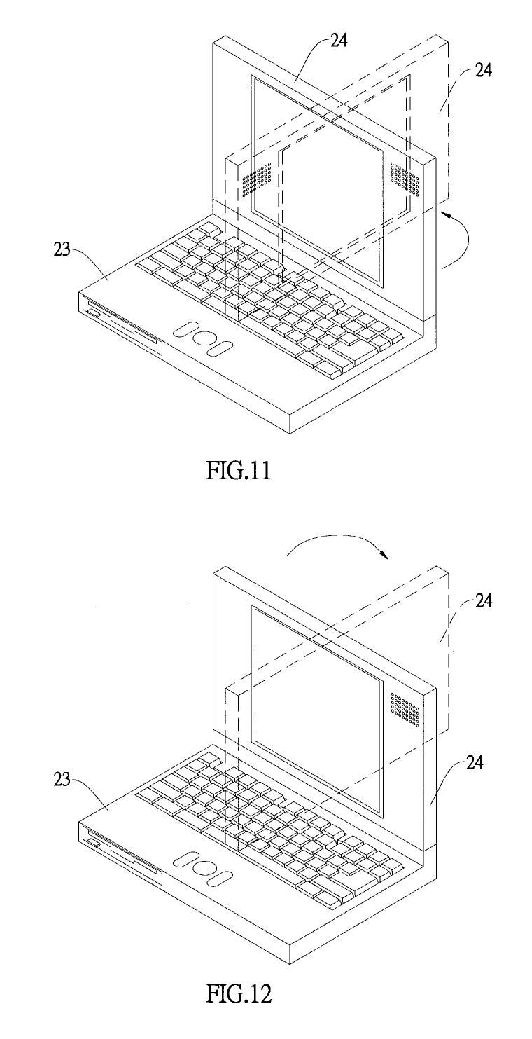

With the above arrangements, it is possible to turn the second member 24 connected to the connecting arms 223 on the swivel shaft 222 relative to the first member 23 connected to the base 21 against different tightness simply by adjusting the screwing element 25. When the screwing element 25 is adjusted to an optimal position relative to the threaded hole 213, the second member 24 connected to the connecting arms 223 on the swivel shaft 222 may be swiveled and located at any desired angular position relative to the first member 23 connected to the base 21 until the projection 221b on the stop plate 221 abuts on the stop rod 216. FIG. 11 shows the second member 24 is turned counterclockwise relative to the first member 23, and FIG. 12 shown the second member 24 is turned clockwise relative to the first member 23.

The swivel bearing 2 of the present invention not only allows the first and the second member 23, 24 connected thereto to turn relative each other clockwise or counterclockwise, but also allows the two members 23, 24 to turn relative to each other against different tightness. The swivel bearing 2 can therefore effectively eliminate the problem of a deformed and/or elastically fatigued elastic plate 13 or other similar elastic member in the conventional swivel bearing necessitating repair or even replacement of the conventional swivel bearing.

The present invention has been described with a preferred embodiment thereof and it is understood that many changes and modifications in the described embodiment can be carried out without departing from the scope and the spirit of the invention as defined by the appended claims.

What is claimed is:

1. A swivel bearing, comprising:
a base for connecting to a first member and being provided at a top with a receiving seat, said receiving seat being provided at a predetermined position with a threaded hole for a screwing element to screw thereinto and thereby set said receiving seat to different tightness; and
a swivel gear being rotatably mounted in said receiving seat of said base for connecting to a second member to be turned relative to said first member;
whereby a tightness against which said first member connected to said base and said second member connected to said swivel gear are turned relative to one another can be adjusted by screwing said screwing element into said threaded hole on said receiving seat by different depths to set said receiving seat to different tightness.

2. The swivel bearing as claimed in claim 1, wherein said receiving seat is provided at another predetermined position with a through hole, via which said screwing element is screwed into said threaded hole.

3. The swivel bearing as claimed in claim 2, wherein said receiving seat includes a central ring portion, in which said swivel gear is mounted, said central ring portion having two diametrically opposite and radially projections, one of which being formed into two radially parallel arms with a clearance existed therebetween; said through hole being transversely provided on one of said two parallel arms and said threaded hole being transversely provided on the other one of said two arms corresponding to and aligned with said through hole, and said screwing element being screwed into said threaded hole via said through hole to bring said two arms of said receiving seat closer to each other to reduce an inner diameter of said ring portion.

4. The swivel bearing as claimed in claim 1, wherein said swivel gear includes a stop plate, a swivel shaft, and two connecting arms; said swivel shaft being rotatably located in said receiving seat on the top of said base, said stop plate being located below said base to connected to a lower side of said swivel shaft by means of screwing elements, and said two connecting arms being fixedly connected at respective inner ends to two diametrically opposite sides of said swivel shaft for said second member to fixedly connect thereto.
